(19) United States
(12) Patent Application Publication
(10) Pub. No.: US 2012/0264839 A1
(43) Pub. Date: Oct. 18, 2012

(54) FLAME RETARDANT BLENDS FOR FLEXIBLE POLYURETHANE FOAMS

(75) Inventors: CARL H. POWELL, JR., WEST LAFAYETTE, IN (US); MATTHEW D. PHILLIPS, Delphi, IN (US); STEPHEN B. FALLOON, LAFAYETTE, IN (US)

(73) Assignee: CHEMTURA CORPORATION, MIDDLEBURY, CT (US)

(21) Appl. No.: 13/403,039

(22) Filed: Feb. 23, 2012

Related U.S. Application Data
(60) Provisional application No. 61/475,361, filed on Apr. 14, 2011.

(51) Int. Cl. C08L 75/04; C08J 9/00; C08K 5/523

(52) U.S. Cl. 521/107; 106/503

(57) ABSTRACT

A flame retardant blend comprises the following components: (a) at least one diester diol of a ring-brominated aromatic compound; (b) at least one alkylated triphenylphosphate; and (c) at least one hindered phenolic anti-oxidant in which the phenolic ring is substituted by at least one alkanoic alkyl ester group in which the alkanoic acid moiety has from about 2 to about 4 carbon atoms and the alkyl group has about 6 to about 16 carbon atoms. The proportions by weight of components (a) and (b) in the blend are in the range of about 30:70 to about 70:30 and the proportion by weight of component (c) to the sum of components (a) and (b) is in the range of about 0.1:100 to 1:100.

This application claims benefit under 35 USC 119(c) of U.S. provisional application No. 61/475,361, filed Apr. 14, 2011, the disclosure of which is incorporated by reference.

### FIELD

This invention relates to flame retardant blends for flexible polyurethane foams.

BACKGROUND

Flexible polyurethane foams are produced by reacting a polyol with a polyisocyanate in the presence of a foam-forming agent. Flexible polyurethane foams are used to make resilient structural materials such as cushioning or padding materials in the furniture and automotive industries. It is known to incorporate fire-retardant additives into such foam materials. However, care has to be taken so that adequate fire retardancy can be achieved without adversely affecting the desired physical properties of such foam materials.

Until recently blends of alkylated triphenyl phosphate with pentabromodiphenyl oxide have been used as flame retardants for flexible polyurethane foams and as flame retardant plasticizers in polyvinyl chloride (PVC) products. However, due to environmental concerns, the use of pentabromodiphenyl oxide is being phased out of use, and alternative flame retardant materials are being sought.

In addition, the manufacture of flexible foams normally involves the production of large billets or buns of foam, which are set aside to cure or to complete the polymerization reaction. Temperatures within the billet from the reaction can reach 150 to 180° C. and higher. The insulating properties of the foam maintain this temperature in the interior of the billet for an extended period of time. Thus, components which are introduced into the foam, including the flame retardant components. should, if possible, be able to withstand high temperatures and not cause scorching or charring to be visible in the foam.

There is therefore significant interest in developing new and scorch resistant flame retardant blends for flexible polyurethane foams.

For example, U.S. Pat. No. 7,153,901 discloses a liquid flame retardant additive composition which comprises a liquid mixture formed from a) at least one reaction product of a brominated aromatic diester diol and an alcohol-reactive agent; b) at least one hindered amine antioxidant; and c) at least one phenolic antioxidant in which the phenolic ring is substituted by an alkanoic acid alkyl ester group in which alkanoic acid moiety has in the range of 2 to about 4 carbon atoms and the alkyl group has in the range of about 6 to about 16 carbon atoms; wherein (1) the proportions of a) to b) are in the range of about 30:70 to about 70:30; (2) the proportions of b) to c) are in the range of about 3:1 to about 1:3; and (3) the weight ratio of a) to b) plus c) is in the range of about 5:1 to about 25:1.

U.S. Pat. No. 7,423,069 discloses a flame retardant blend for flexible polyurethane foams comprising a dialkyl tetrahalophthalate ester and a phosphorus-containing flame retardant having at least about 5 wt. % phosphorus, preferably an (alkyl substituted) aryl phosphate, such as butylated triphenyl phosphate, or isopropylated triphenyl phosphate.

U.S. Published Patent Application No. 2009/0143494 discloses flame retardant additive for polyurethanes formed from (A) at least one bis(alkanoic acid ester) of a ring-brominated aromatic diester diol; (B) liquid alkylated triphenyl phosphate having an approximate average formula (RₓPhO)₃P═O) in which each R is, independently, a hydrogen atom or a C, alkyl group and x is an average number in the range of about 0.2 to 3; and (C) at least one alicyclic phosphonate ester having 1, 2 or 3 phosphorus atoms in the molecule, at least one of which is part of an alicyclic ring system, and having a phosphorus content of at least about 15 wt %.

According to the present invention, a novel flame retardant blend has now been developed that prevents scorch and discoloration, as well as imparting flame retardancy, to flexible polyurethane foams. The novel blend is a specific mixture of at least one brominated aromatic diester diol, at least one alkylated triphenylphosphate and at least one hindered phenolic anti-oxidant.

### SUMMARY

In one aspect, the invention resides in a flame retardant blend comprising the following components:
(a) at least one diester diol of a ring-brominated aromatic compound;
(b) at least one alkylated triphenylphosphate; and
(c) at least one hindered phenolic anti-oxidant in which the phenolic ring is substituted by at least one alkanoic alkyl ester group in which the alkanoic acid moiety has from about 2 to about 4 carbon atoms and the alkyl group has about 6 to about 16 carbon atoms.
   wherein the proportions by weight of components (a) and (b) in the blend are in the range of about 30:70 to about 70:30 and the proportion by weight of component (c) to the sum of components (a) and (b) is in the range of about 0.1:100 to 1:100.

Conveniently, component (a) comprises a diester of tetrabromophthalic acid with a C₂ to C₆ polyhydric aliphatic alcohol, especially diethylene glycol, and a C₂ to C₈ alkylene oxide, especially ethylene or propylene oxide.

Conveniently, component (a) has a viscosity of about 7,500 to about 130,000 cps, such as about 15,000 to about 35,000 cps, at 25° C.

Conveniently, component (b) comprises a propylated or butylated triphenylphosphate.

Conveniently, component (b) has a viscosity of about 15 to about 300 cps.

Conveniently, the proportions by weight of components (a) and (b) in the blend are in the range of about 40:60 to about 60:40.

In a further aspect, the invention resides in a process of producing a flexible polyurethane foam composition, the process comprising:
(i) providing a flame retardant blend as described herein;
(ii) forming a polymerization formulation comprising an isocyanate, a polyol, a blowing agent and the flame retardant blend in a amount sufficient to provide flame retardancy and scorch resistance to the flexible foam being produced, and
(iii) polymerizing the resultant formulation to form a flame retardant scorch resistant flexible polyurethane foam.

Conveniently, said polymerization formulation comprises from about 3 wt % to about 15 wt % of said flame retardant blend.

Conveniently, said flexible polyurethane foam has a density of 8 to 48 kg/m³.

The invention also resides in the flame retardant flexible polyurethane foam comprising from about 3 wt % to about 15 wt % of the flame retardant blend of the present invention, and in particular the the flame retardant flexible polyurethane foam produced by the present process.

### DETAILED DESCRIPTION

Described herein is a flame retardant blend and its use in imparting flame, scorch and discoloration resistance to flexible polyurethane foams and in particular flexible polyurethane foams having a density of 8 to 48 kg/m³.

The present blend comprises at least three components including (a) at least one diester diol of a ring-brominated aromatic compound; (b) at least one alkylated triphenylphosphate; and (c) at least one hindered phenolic anti-oxidant in which the phenolic ring is substituted by at least one alkanoic alkyl ester group in which the alkanoic acid moiety has from about 2 to about 4 carbon atoms and the alkyl group has about 6 to about 16 carbon atoms.

Component (a) typically comprises a diester of tetrabromophthalic acid or acid anhydride (TBPA) with a C₂ to C₆ polyhydric aliphatic alcohol (PAA), preferably diethylene glycol, and a C₂ to C₈ alkylene oxide (AO), preferably propylene oxide. In one practical embodiment, in which the PAA is diethylene glycol and the AO is propylene oxide, the diester diol has the following formula:

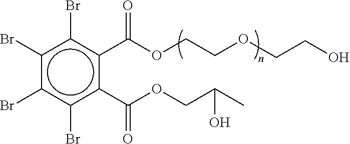

where n is typically in the range from about 1 to about 5.

The diester diol preferably has a viscosity at 25° C. of about 7,500 to about 130,000 cps. such as from about 15,000 to about 50,000 cps and especially from about 15,000 to about 35,000 cps. Thus, in its low viscosity forms, the diester diol is pourable at room temperature and can be pumped using standard machine pumps commonly used for spray polyurethane foam, flexible slab stock, flexible box pour, rigid discontinuous lamination panels, rigid continuous lamination panels, pour-in-place/molded applications; as well as, adhesive applications.

Suitable diester diols for use as component (a) of the present blend are commercially available such as, for example, Great Lakes PHT4-Diol™ supplied by Chemtura Corporation (a mixed ester of tetrabromophthalic anhydride with diethylene glycol and propylene oxide) and Firemaster® 520 supplied by Chemtura Corporation (a mixed ester of tetrabromophthalic anhydride with diethylene glycol and ethylene oxide). Great Lakes PHT4-Diol™ LV supplied by Chemtura Corporation (a mixed ester of tetrabromophthalic anhydride with diethylene glycol and propylene oxide) that is specially made to emphasize low viscosity yet maintain flame retardant properties of Great Lakes PHT4-Diol™ is a suitable diester diol, also.

In addition, and especially in its lower viscosity forms, the diester diol can be produced by the reaction of tetrabromophthalic anhydride (TBPA) with both a C₂ to C₆ polyhydric aliphatic alcohol (PAA) and an alkylene oxide (AO) in a single stage in the liquid phase and in the absence of an organic solvent, such as toluene. The process typically involves adding the TBPA to the PAA to form a thick, but stirrable, slurry. Potassium hydroxide is then normally added to the slurry partially to neutralize residual acid from the TBPA and partly to act as a chain extension catalyst to control the overall molecular weight and viscosity of the product. The AO is then added to slurry and the ingredients are blended together to form a homogeneous reaction mixture having the following molar composition:
PAA:TBPA=about 1 to about 2.5:1;
AO:TBPA=about 1.5 to about 2.0:1; and
KOH:TBPA=about 0.001 to about 0.05:1.

The amount of PAA added to the reaction mixture can be varied to adjust the viscosity of the final diester diol, with higher values within the PAA:TBPA range given above resulting in lower viscosity products. To produce a very low viscosity product (about 15,000 to about 35,000 cps at 25° C.). PAA:TBPA mole ratio is generally adjusted to be in the range of about 1.5 to about 2:1

The resultant reaction mixture is then heated under stirring to a temperature of at least 50° C., generally between about 60° C. and about 65° C. to initiate the esterification reaction. Since the reaction is exothermic, the temperature may rise as the reaction proceeds and so cooling is generally applied to the reaction mixture to retain the temperature at or below 120° C. The reaction mixture is then maintained at this temperature for about 2 hours to about 8 hours to complete the reaction. The reaction is terminated when the diester composition has an acid value equal to or less than 0.25 mg KOH/gm, generally between about 0.04 and about 0.10 mg KOH/gm, of the diester composition. After the reaction has been terminated, residual propylene oxide is bled to a scrubber and the reaction mixture held under vacuum to remove volatiles.

Component (b) of the present blend comprises at least one alkylated triphenylphosphate and particularly a propylated or butylated triphenylphosphate. Examples of suitable materials for component (b) include tris(alkylphenyl)phosphates, di(alkylphenyl)phenylphosphates, and (alkylphenyl)diphenylphosphates. Typically, component (b) has a viscosity at 25° C. of about 15 to about 300 cps.

Generally, the proportions by weight of components (a) and (b) in the present flame retardant blend are in the range of about 30:70 to about 70:30, such as about 40:60 to about 60:40.

Component (c) of the present blend comprises at least one hindered phenolic anti-oxidant in which the phenolic ring is substituted by at least one alkanoic alkyl ester group in which the alkanoic acid moiety has from about 2 to about 4 carbon atoms and the alkyl group has about 6 to about 16 carbon atoms. Specific examples of such hindered phenolic compounds include Anox 1315, Anox 70, Anox 330, Naugard 431, and Naugard BHT, all supplied by Chemtura Corporation. There are many other examples of phenolic antioxidants that are available from other suppliers as well. Typically, component (b) has a viscosity at 25° C. of about 200 to about 8000 cps. Generally, the proportion by weight of component (c) to the sum of components (a) and (b) is in the range of about 0.1:100 to 1:100, such as in the range of about 0.15:100 to 0.25:100.

The overall flame retardant blend generally has a viscosity at 25° C. of about 500 to about 5000 cps, typically about 800 to about 2000 cps.

The present flame retardant blend not only offers flame retardancy but anti-scorch/anti-discoloration properties to any free-rise, slabstock or molded polyurethane foam prepared in the range of 8 kg/m³ to 48 kg/m³, where the high exotherm of the foam reaction and the insulation properties of the resultant polyurethane foam make the foam susceptible to discoloration and acid degradation. This blend is particularly useful with slabstock prepared polyurethane foams with densities in the range of 8 kg/m³ to 48 kg/m³, which are highly susceptible to discoloration and pose a fire hazard within the manufacturing environment. The blend is added to the polyurethane reaction mixture comprising an isocyanate, a polyol, and a blowing agent, typically with the present blend comprising between about 5 wt % and about 13 wt % of the overall reaction mixture.

The invention will now be more particularly described with reference to the following non-limiting Examples.

### EXAMPLE 1

A flame retardant blend was produced by mixing together (a) 39.90 parts by weight of Great Lakes PHT4-Diol™ LV, (b) 59.85 parts by weight of a butylated triphenylphosphate and (c) 0.25 parts by weight of Anox 1315. The resultant blend had a viscosity at 25° C. of about 843 cps.

### EXAMPLES 2 to 4

The flame retardant blend of Example 1 was used to produce three flexible polyurethane foam samples having different density values using the components specified in Table 1. In Table 1, all components are expressed in parts per hundred polyol (php).

TABLE 1

| Component | Ex 2 | Ex 3 | Ex 4 |
|---|---|---|---|
| Polyol | 100.0 | 100.0 | 100.0 |
| (Dow Voranol 235-056, 56.0 | | | |
| OH, 3000 Molecular Weight) | | | |
| Dichloromethane | 1.0 php | — | — |
| Water | 6.0 php | 4.5 php | 3.4 php |
| Amine Catalyst | 0.5 php | 0.5 php | 0.5 php |
| (Air Products Dabco 8264) | | | |
| Silicone Surfactant | 1.0 php | 1.0 php | 1.0 php |
| (Air Products Dabco DC5160) | | | |
| Tin Catalyst | 0.24 php | 0.21 php | 0.14 php |
| (Evonik Kosmos 29) | | | |
| Flame Retardant | 25.0 php | 17.0 php | 9.0 php |
| (Chemtura CN-3394) | | | |
| TDI | 73.8 php* | 57.8 php* | 46.1 php* |
| (Bayer Mondur TD-80 grade | | | |
| A) | | | |
| Density | 19 kg/m³ | 24 kg/m³ | 29 kg/m³ |

*Note: TDI equivalency addition level corresponds to 110 isocyanate index. 110 isocyanate index represents a 1.1:1 stoichiometry of toluene diisocyanate to hyrodroxyls present in formulation.

The properties of the resultant flame retardant foams were measured at load levels that would pass California Technical Bulletin 117 Part A and Part D. The results are summarized in Table 2 and Table 3. Evaluation of foam samples included measurement of airflow, compression set, density and indentation force deflection (IFD).

Air flow is defined as the volume of air per second at standard temperature and atmospheric pressure required to maintain a constant pressure differential of 125 Pa across a flexible foam specimen approximately 50×50×25 mm. These examples were measured according to ASTM D 3574-05, Test G.

Compression set measures the loss of resiliency when foam is held under a specified compression. These examples were measured according to ASTM D 3574-05, Test D at 90% compression.

Density is the weight per unit volume of the foam normally expressed in kilograms per cubic meter (kg/m³). These examples were measured according to ASTM D 3574-05, Test A.

Indention force deflection measures the load necessary to deflect the foam by a stated percentage of its original height. These examples were measured according to ASTM D 3574-05, Test B₁. An indentor foot; as described in the method, is pressed into the flexible foam sample until the foam is compressed the indicated value, expressed as a percent of the original height. The result is stated as a unit of force (Newtons). Foam blocks tested are 380×380×100 mm.

TABLE 2

| | | | 90% Compression | 25% | |
|---|---|---|---|---|---|
| | Density | Airflow | Set | IFD | 65% IFD |
| Example | (kg/m³) | (m³/min) | (% height recovery) | (N) | (N) |
| 2 | 19 | 0.163 | 12.2 | 191 | 387 |
| 3 | 24 | 0.107 | 8.7 | 222 | 454 |
| 4 | 29 | 0.049 | 8.8 | 245 | 498 |

TABLE 3
California Technical Bulletin 117 Burn Results

| | Part A | Part A | Part D | Pass/ |
|---|---|---|---|---|
| Example | (Aged-Average) | (Initial- Average) | (% Retention) | Fail |
| 2 | 1 sec./3.1″ | 0.6 sec./3.1″ | 96.82% | Pass/ |
| | | | | Pass |
| 3 | 0.6 sec./3.0″ | 0 sec./2.5″ | 98.81% | Pass/ |
| | | | | Pass |
| 4 | 0.6 sec./3.0″ | 0 sec./2.6″ | 89.69% | Pass/ |
| | | | | Pass |

The foam of Example 3 was tested against the California Technical Bulletin 117 combustibility part A and part D and the scorch data are shown in Table 4, which also provides scorch data for two other foam samples also having a density of 24 kg/m³ but employing as flame retardants TDCP [tris(1,3-dichloro-2-propyl) phosphate] and Firemaster® 600 (a Chemtura flame retardant that contains a blend of bromine and phosphorus compounds).

Scorch is defined as polymer degradation and discoloration. It can be caused by excessive heat from the water-isocyanate reaction during foam formation and/or additive induced discoloration within the foam. Scorch is normally indicated by a yellow or brown discoloration; particularly in the center of a foam billet. Scorch readings for these examples were measured based upon a modified version of Reale and Jacobs' predictive scorch test published in the Journal of Cellular Plastics 1979; 15; 311.

TABLE 4

| Flame Retardant | ΔE^{a} | YI D1925^{b} |
|---|---|---|
| TDCP | 10.67 | 16.20 |
| Example 3 | 3.21 | 2.36 |
| Firemaster ® 600 | 4.46 | 1.20 |

^{a}ΔE refers to delta E or DE.
^{b}YI D1925 refers to Yellowness Index per ASTM Method D 1925.

ΔE or color difference is a measure of how different the material is in color from the standard. A color difference meter is used to give a numerical reading based upon rating three color characteristics—lightness (L), yellowness (b) and redness (a), which are compared to a white color standard. From these numbers, a value for color difference or ΔE can be calculated according to the equation: ΔE=(ΔL²+Δa²+Δb²)^{1/2}. A change in ΔE signifies a change in color from the white tile standard used by the color difference meter. Higher ΔE numbers signify more change in color from the white tile standard. Lower ΔE numbers signify less change in color from the white tile standard. The best ΔE value for a foam would be zero which indicates no color difference measured between foam sample and white tile standard.

Y1 D1925 refers to Yellowness Index as measured per ASTM Method D 1925. Visually, yellowness is associated with scorching, discoloration and foam degradation. Yellowness indices are used to quantify these types of degradation with a single value. Therefore; higher yellowness index results indicate more color. Lower yellowness index results indicate less color. The best yellowness index value for a foam would be zero which indicates no yellowness detected in foam sample.

1. A flame retardant blend comprising the following components:
(a) at least one diester diol of a ring-brominated aromatic compound;
(b) at least one alkylated triphenylphosphate; and
(c) at least one hindered phenolic anti-oxidant in which the phenolic ring is substituted by at least one alkanoic alkyl ester group in which the alkanoic acid moiety has from about 2 to about 4 carbon atoms and the alkyl group has about 6 to about 16 carbon atoms.
wherein the proportions by weight of components (a) and (b) in the blend are in the range of about 30:70 to about 70:30 and the proportion by weight of component (c) to the sum of components (a) and (b) is in the range of about 0.1:100 to 1:100.

2. The blend of claim 1, wherein component (a) comprises a diester of tetrabromophthalic acid with a C₂ to C₆ polyhydric aliphatic alcohol and a C₂ to C₈ alkylene oxide.

3. The blend of claim 1, wherein component (a) comprises a diester of tetrabromophthalic acid with diethylene glycol and ethylene or propylene oxide.

4. The blend of claim 1, wherein component (a) has a viscosity of about 7,500 to about 130,000 cps at 25° C.

5. The blend of claim 1, wherein component (a) has a viscosity of about 15,000 to about 35,000 cps at 25° C.

6. The blend of claim 1, wherein component (b) comprises a propylated or butylated triphenylphosphate.

7. The blend of claim 1, wherein the proportions by weight of components (a) and (b) in the blend are in the range of about 40:60 to about 60:40.

8. A process of producing a flexible polyurethane foam composition, the process comprising
(i) providing a flame retardant blend comprising the following components:
(a) at least one diester diol of a ring-brominated aromatic compound;
(b) at least one alkylated triphenylphosphate; and
(c) at least one hindered phenolic anti-oxidant in which the phenolic ring is substituted by at least one alkanoic alkyl ester group in which the alkanoic acid moiety has from about 2 to about 4 carbon atoms and the alkyl group has about 6 to about 16 carbon atoms, wherein the proportions by weight of components (a) and (b) in the blend are in the range of about 30:70 to about 70:30 and the proportion by weight of component (c) to the sum of components (a) and (b) is in the range of about 0.1:100 to 1:100.
(ii) forming a polymerization formulation comprising an isocyanate, a polyol, a blowing agent and the flame retardant blend in an amount sufficient to provide flame retardancy and scorch resistance to the flexible foam being produced, and
(iii) polymerizing the resultant formulation to form a flame retardant scorch resistant flexible polyurethane foam.

9. The process of claim 8, wherein component (a) comprises a diester of tetrabromophthalic acid with a C₂ to C₆ polyhydric aliphatic alcohol and a C₂ to C₈ alkylene oxide.

10. The process of claim 8, wherein component (a) comprises a diester of tetrabromophthalic acid with diethylene glycol and ethylene or propylene oxide.

11. The process of claim 8, wherein component (a) has a viscosity of about 7,500 to about 130,000 cps at 25° C.

12. The process of claim 8, wherein component (a) has a viscosity of about 15,000 to about 35,000 cps at 25° C.

13. The process of claim 8, wherein component (b) comprises a propylated or butylated triphenylphosphate.

14. The process of claim 8, wherein the proportions by weight of components (a) and (b) in the blend are in the range of about 40:60 to about 60:40.

15. The process of claim 8, wherein the polymerization formulation formed in (ii) comprises between about 3 wt % and about 15 wt % of the flame retardant blend.

16. The process of claim 8, wherein flexible polyurethane foam has a density of about 8 to about 48 kg/m³.

17. A flame retardant flexible polyurethane foam comprising from about 3 wt % to about 15 wt % of the flame retardant blend of claim 1.

18. The flame retardant flexible polyurethane foam obtained by the process of claim 8.
